(19) United States
(12) Patent Application Publication
(10) Pub. No.: US 2023/0220237 A1
(43) Pub. Date: Jul. 13, 2023

(54) UTILIZATION OF POLYUREA-BASED COATINGS IN ENHANCING STRUCTURAL INTEGRITY OF POLYETHYLENE (PE) / POLYPROPYLENE (PP) PIPES AND PIPE FITTINGS

(71) Applicant: Abu Dhabi National Oil Company, Abu Dhabi (AE)

(72) Inventors: Abdallah AL TAMIMI, Abu Dhabi (AE); Alan NELSON, Abu Dhabi (AE)

(21) Appl. No.: 18/001,423

(22) PCT Filed: Jun. 17, 2021
(86) PCT No.: PCT/IB2021/055355

§ 371 Date: Dec. 9, 2022

Related U.S. Application Data
(60) Provisional application No. 63/040,023, filed on Jun. 17, 2020.

(51) Int. Cl. C09D 175/02; F16L 9/133; F16L 9/14

(52) U.S. Cl. CPC C09D 175/02; F16L 9/133; F16L 9/14

(57) ABSTRACT

The present invention is directed to a pipe or pipe fitting comprising a polyurea-based coating, wherein the pipe or pipe fitting is made from plastic, wherein the plastic is selected from polyolefins, preferably polyethylene (PE) and/or polypropylene (PP). The polyurea-based coating allows for enhanced mechanical strength and performance of the pipe or pipe fitting comprising the polyurea-based coating compared to a corresponding pipe or pipe fitting not comprising the polyurea-based coating, wherein the mechanical strength and performance relate to hydrostatic pressure resistance according to the Hydrostatic Pressure Test under ISO 1167 and/or resistance to failure according to the Notched Pipe Test under ISO 13479 and/or long-term hydrostatic strength according to ISO 9080:2012 standard. This makes the pipes suitable for high-pressure applications, for example in the Oil and Gas industry, in particular to use of plastic pipes of the present invention comprising a polyurea-based coating for conveying process fluids in both water and hydrocarbon environments.

### FIELD OF THE INVENTION

The present invention generally relates to piping/pipeline applications. Specifically, the present invention is directed to polyurea-based coatings for plastic pipes and pipe fittings made from polyethylene (PE) and/or polypropylene (PP). The polyurea-based coating allows for enhanced mechanical strength and performance of the plastic pipes, in particular improved hydrostatic pressure resistance according to the Hydrostatic Pressure Test under ISO 1167 and/or resistance to failure according to the Notched Pipe Test under ISO 13479 and/or long-term hydrostatic strength according to ISO 9080:2012 standard, which makes the pipes suitable even for high-pressure applications. The present invention also relates to use of plastic pipes equipped with polyurea-based coatings in high-pressure applications, for example in the Oil and Gas industry.

### BACKGROUND OF THE INVENTION

Pipes are used for conveying fluids, either gaseous or liquid, or even bulk solids. Typical fluids transported in pipes are, for example, natural gas, crude oil or refined petroleum, or water or water vapor. Also, in chemical and petroleum industry, there are numerous fluid systems of pipes and pipelines containing many types of liquids or gases, including hazardous chemicals. In some piping applications, pipe material is required to withstand harsh physical and chemical conditions, such as high pressures and/or high temperatures and/or corrosive substances. Moreover, pipes and pipeline applications also afford longevity of the pipe material.

For example, in the field of Oil and Gas industry, enhanced oil recovery (EOR, also referred to as tertiary recovery) has become an important method for exploiting reservoirs which cannot be extracted otherwise. EOR techniques such as gas injection, thermal injection or chemical involve application of high pressures and chemicals. EOR techniques often come along with the injection of alkaline or caustic solutions, or high levels of CO₂ or H₂S. This, however, results in the fluid stream conveyed in a pipeline to be more corrosive. Against this background, the risk of pipe material failure is high. Thus, in EOR techniques, the demands on the pipe material are extremely high.

Generally, pipes can be made from many types of materials, for example and not limited to ceramic, glass, fiberglass, metals, concrete and plastic. The type of material is crucial for the application a pipe is intended to be used for.

For example, pipes made from mineral materials such as concrete, ceramic or vitrified clay are commonly used for low-pressure applications such as gravity flow or drainage. Oil pipelines are made from steel or plastic tubes. Natural gas (and similar gaseous fuels) are pressurized into liquids known as Natural Gas Liquids (NGLs) for which pipelines made from carbon steel are used.

In the field of piping and/or pipeline applications, corrosion is a major concern, because corrosion negatively affects the structural integrity of pipes. During use of a pipe, the environment around the pipe as well as the fluid conveyed in the pipe may cause corrosion and/or decomposition of the pipe material. Pipes may also be deteriorated from wear or aging.

Negative effects on the structural integrity of a pipe material, however, can lead to increased permeability to liquids and gases, and even perforations in the pipe resulting in leakages. Leakages from pipelines often cause hazardous situations with risks for the health and the environment. For example, gas leaks, e.g. in natural gas lines allow flammable and explosive gases to leak out, or oil spills represent major negative impacts on the environment. Therefore, means are needed to enhance the structural integrity and longevity of pipe materials.

During use of a pipe, the structural integrity and longevity of the pipe material is crucial for reliable and safe conveyance of the fluids contained in the pipe. To protect pipes from impact, abrasion, and corrosion, a variety of methods can be used, e.g. wood lagging (wood slats), or concrete coating. Also, reinforcements with polymeric materials such as high-density polyethylene are known.

In the prior art, oil pipelines are commonly made from steel or plastic tubes. Natural gas (and similar gaseous fuels) are pressurized into liquids known as natural gas liquids (NGLs) for which usually pipelines made from carbon steel are used. However, the disadvantage of carbon steel is, that it easily deteriorates due to corrosion. Therefore, pipes of carbon steel do not only suffer from material degradation but are also cost-intensive to maintain. As an alternative, corrosion resistant alloys are used in the prior art. However, the disadvantage of corrosion resistant alloys is, that these materials have a lengthy lead time and are often very expensive compared to carbon steel, which prevents widespread use.

Against this background, non-metallic piping/pipeline systems have been considered in the prior art as solutions to many applications, specifically in the conveyance of fluids such as water and hydrocarbons in the gas and oil industry. However, non-metallic materials also come along with disadvantageous limitations in terms of material properties such as insufficient temperature and/or pressure resistance, strength, impact, flammability, and/or permeability.

In the prior art, non-metallic pipes made from reinforced thermoplastics (RTP) have been used, in particular for multi-layer non-metallic pipe systems. However, pipes made from RTP are cost-intensive and prevent large-scale use. Another approach known in the prior art is reinforcement of PE and PP by materials such as glass-reinforced polyester (GRP) as an outer shell. The GRP shell provides for higher pressure resistance and better mechanical properties. PE/GRP and PP/GRP pipes are used in piping systems conveying corrosive media, for example caustic soda and/or phosphoric acid. However, also pipes made from PE/GRP and/or PP/GRP do not withstand pressures involved in HPTP applications in gas or oil drilling of up to 2,000 bar. Further disadvantages are the reduced compressive strength and stiffness, the surface quality and the problem that thermoplastics tend to creep, especially under long-term loads and elevated temperatures. Also, in the prior art, glass reinforced epoxy pipes (GRE) have been used. However, GRE pipes disadvantageously have a brittle nature providing for the risk of failure during operation. Also, the reinforcement layer in both RTP and GRE technologies is only applicable to the outside of a non-metallic pipe system.

Accordingly, there is demand for improved non-metallic pipes, specifically non-metallic pipes suitable for applications and operating environments involving harsh physical and chemical conditions, such as high pressures and/or high temperatures and/or corrosive substances. Also, there is need for reinforcement technologies allowing for a better viscoelastic behavior and ductility and less vulnerability to cracking.

In this regard, pipes made from polyethylene (PE) and/or polypropylene (PP) are promising candidates. Generally, PE and PP both are lightweight and still provide for high impact, good stiffness and high chemical resistance. The performance of polyethylene has been continuously improved allowing for widespread use in water and gas conveyance. A particularly suitable form of PE is high-density polyethylene (HDPE). HDPE pipes are increasingly used for replacing ageing concrete or steel mains pipelines. HDPE provides for resistance to chemicals and corrosion, a high degree of impermeability and material strength. HDPE pipes also show improved long-term strength, stress crack resistance, and resistance to rapid crack propagation (RCP). These material properties allow for usage of HDPE pipes in high-pressure pipelines with up to 7 bar. However, conventional pipes made from PE, PP and/or HDPE cannot be used for high pressure and high temperature (HPTP) applications in gas or oil drilling involving pressures up to 2,000 bar (about 30,000 psi) and temperatures of up to 290° C. (about 550° F.).

Therefore, there is need in the art to provide for increased mechanical strength and performance (in particular pressure rating such as to hydrostatic pressure resistance according to the Hydrostatic Pressure Test under ISO 1167 and/or resistance to failure according to the Notched Pipe Test under ISO 13479 and/or long-term hydrostatic strength according to ISO 9080:2012 standard) of plastic pipes, for example made from PE and/or PP. In particular, there is need in the art for pipes made from polyolefins such as PE and/or PP which can withstand high pressures, specifically pressures typically involved in high pressure and high temperature (HPTP) applications in gas or oil drilling of up to 2,000 bar.

Polyurea coatings have been widely used in the prior art to reinforce substrates, mainly in the construction and automotive sectors. Polyurea-based coatings are highly elastic, flexible, and durable, also providing for water-tight seals with strong protection against material degradation or deterioration, for example by abrasion, corrosion, or aggressive chemicals.

Polyurea was originally developed to protect tabletop edges which led to the development of two-component polyurethane and polyurea spray elastomers took place in the 1990s by Mark S. Barton and Mark Schlichter (U.S. Pat. No. 5,534,295 patent) Polyurea has been employed in coatings on large surface area projects, such as secondary containment, manhole and tunnel coatings, tank liners, and truck bed liners. Polyurea provides for adhesion to concrete and steel. Polyurea can provide for excellent tensile strength of up to 40 MPa (6000 psi) and over 500% elongation, which renders polyurea a strong coating.

Also, polyurea-based coatings are known in the art to reinforce steel pipes, for example in the gas and oil industry, where corrosion of iron-based pipings is a major concern. However, there is only limited use of polyurea-based coatings on non-metallic pipes, especially PE and/or PP pipes.

For example, CN205842016 (U) describes a high-pressure-resistant plastic composite pipe used as an oil pipeline. The pipe comprises an epoxy powder anticorrosive layer and a flexible polyurea outer protective layer which are sequentially arranged on the outer surface of the plastic composite pipe. CN205842016 (U) does not provide for any details on high-pressure resistance of the high-pressure-resistant plastic composite pipe or the polyurea layer. The pipes described in CN205842016 (U), however, disadvantageously necessitate an epoxy powder layer between the polyethylene tube and the polyurea layer.

Accordingly, there is need for an improved pressure rating of PE and/or PP pipes allowing to use such improved PE and/or PP pipes in high-pressure applications. Specifically, there is need for optimized low-cost plastic pipes providing for enhanced structural performance and/or improved high-pressure rating.

### SUMMARY OF THE INVENTION

In one aspect, the present invention solves the shortcomings of the prior art by providing a pipe or pipe fitting comprising a polyurea-based coating, wherein the pipe or pipe fitting is made from plastic, wherein the plastic is selected from polyolefins, preferably polyethylene (PE) and/or polypropylene (PP), and wherein the mechanical strength and performance of the pipe or pipe fitting comprising the polyurea-based coating is improved over a corresponding pipe or pipe fitting not comprising the polyurea-based coating, wherein the mechanical strength and performance relate to hydrostatic pressure resistance according to the Hydrostatic Pressure Test under ISO 1167 and/or resistance to failure according to the Notched Pipe Test under ISO 13479 and/or long-term hydrostatic strength according to ISO 9080:2012 standard.

In another aspect, the present invention relates to use of a pipe or pipe fitting according to the present invention for applications requiring enhanced hydrostatic pressure resistance according to the Hydrostatic Pressure Test under ISO 1167 and/or increased resistance to failure according to the Notched Pipe Test under ISO 13479 and/or long-term hydrostatic strength according to ISO 9080:2012 standard.

In a further aspect, the present invention relates to use of a pipe or pipe fitting according to the present invention for a high pressure and high temperature (HPTP) application in gas or oil drilling.

In another aspect, the present invention relates to use of a pipe or pipe fitting according to the present invention for conveying fluids and/or bulk solids.

In yet another aspect, the present invention relates to a multilayer pipe or pipe fitting, preferably a reinforced thermoplastic pipe (RTP), comprising a pipe or pipe fitting according to the present invention.

In a further aspect, the present invention relates to a system comprising at least one pipe and/or at least one pipe fitting according to the present invention and/or at least one multilayer pipe or pipe fitting according to the present invention.

For a detailed understanding of the present invention, reference should be made to the following detailed description in conjunction with the drawings and embodiments according to the present invention.

### BRIEF DESCRIPTION OF THE DRAWINGS

FIG. 1 shows a cross section of a pipe according to the present invention 1 equipped with a polyurea-based coating 2 at the outer wall 3 of the pipe.

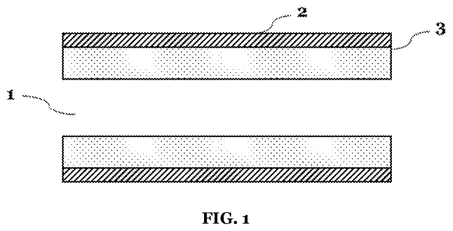

FIG. 2 shows a longitudinal section of a pipe according to the present invention 1 equipped with a polyurea-based coating 2 at the outer wall 3 of the pipe.

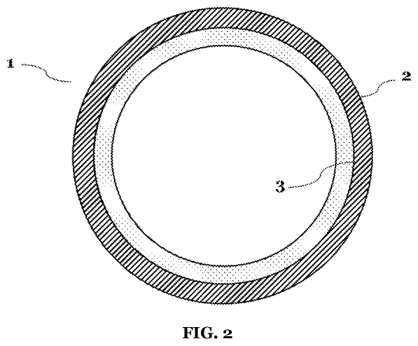

FIG. 3 shows a cross section of a pipe according to the present invention 1 equipped with a polyurea-based coating 2 at the inner wall 4 of the pipe.

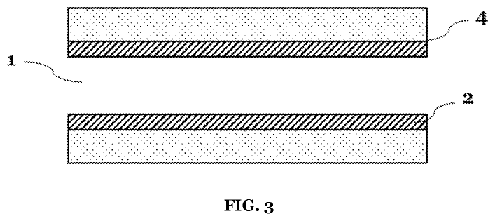

FIG. 4 shows a longitudinal section of a pipe according to the present invention 1 equipped with a polyurea-based coating 2 at the inner wall 4 of the pipe.

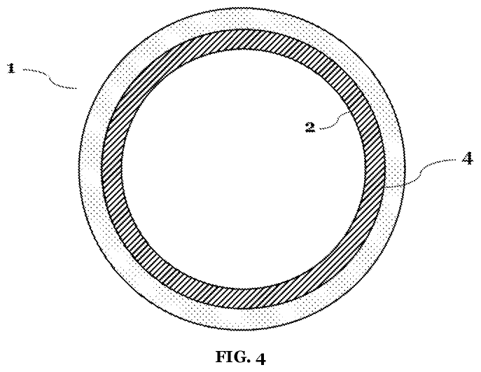

FIG. 5 shows polyurea-coated pipes according to samples 1, 2 and 4 of the present invention, which were studied in a Hydrostatic Pressure Test (HPT) according to ISO 1167.

### DEFINITIONS OF TERMS AS USED IN CONTEXT OF THE PRESENT INVENTION

The term “pipe” as used in context of the present invention relates to pipes, pipings, pipelines and tubes according to any applicable standard. The term “pipe” also refers to pipe assemblies and fittings such as elbows, tees, or any custom configurations. A pipe is a tubular section or hollow cylinder, usually but not necessarily of circular cross-section, used mainly to convey substances which can flow—liquids and gases (fluids), slurries, powders and masses of small solids. It can also be used for structural applications. A pipe may be generally specified by a nominal diameter with a constant outside diameter (OD) and a schedule that defines the thickness (wall thickness).

The term “pipeline” as used in context of the present invention relates to a system of pipes for conveyance or transportation of a liquid or gas through, preferably over long distances.

The term “coating” as used in context of the present invention relates to a covering that is applied to the surface of an object, usually referred to as the substrate. In context of the present invention, the substrate preferably is a pipe or pipe fitting. The purpose of applying the coating may be decorative, functional, or both. The coating itself may be an all-over coating, completely covering the substrate, or it may only cover parts of the substrate.

The term “high pressure and high temperature (HPTP) application” as used in context of the present invention relates to applications, methods and processes involving a pressure of between 1 bar to 2500 bar, preferably of between 70 bar to 2000 bar, more preferably of between 300 to 1700 bar, even more preferably of between 500 bar to 1400 bar, most preferably of between 680 bar to 1100 bar. The term “high pressure and high temperature (HPTP) application” as used in context of the present invention includes also conditions as defined by the American Petroleum Institute (API) or the Society of Petroleum Engineers (SPE): For example, according to SPE, Ultra-HPTP corresponds to pressures of up to 30,000 psi (2068 bar), Extreme-HPTP to up to 20,000 psi (1379 bar) and HTPT to up to 15,000 psi (1034 bar). API code API PER 15K refers to HPHT as conditions with pressures above 15,000 psi (1034 bar).

The terms “polyurea coating” or “polyurea-based coating” as used in context of the present invention relates to compositions comprising polyurea which may be applied as a coating to substrates. “Polyurea coating” or “polyurea-based coating” may, for example, be rubber-like, soft elastic to hard. Also, the terms “polyurea coating” or “polyurea-based coating” refer to any known polyurea or polyurea-based coating known in the prior art. For example, it is known in the art to use two-component polyurea spray systems providing for elastomeric protective coatings for various substrates. Commercially available polyurea-based coatings which may be used in the present invention are, for example, “Line-X XS-430” or “Line-X XS-350” from Line X LLC, Huntsville, Ala., USA.

The term “mechanical strength and performance” as used in context of the present invention relates to a substrate's, in particular a pipe's, behavior under and response to physical stress such as force, pressure, and/or temperature exerted on the substrate, or pipe, respectively. In particular, mechanical strength and performance relate to hydrostatic pressure resistance according to the Hydrostatic Pressure Test under ISO 1167 and/or resistance to failure according to the Notched Pipe Test under ISO 13479 and/or long-term hydrostatic strength according to ISO 9080:2012 standard.

### DETAILED DESCRIPTION OF THE INVENTION

The present invention relates to a pipe or pipe fitting comprising a polyurea-based coating, wherein the pipe or pipe fitting is made from plastic, wherein the plastic is selected from polyolefins, preferably polyethylene (PE) and/or polypropylene (PP), and wherein the mechanical strength and performance of the pipe or pipe fitting comprising the polyurea-based coating is improved over a corresponding pipe or pipe fitting not comprising the polyurea-based coating, wherein the mechanical strength and performance relate to hydrostatic pressure resistance according to the Hydrostatic Pressure Test under ISO 1167 and/or resistance to failure according to the Notched Pipe Test under ISO 13479 and/or long-term hydrostatic strength according to ISO 9080:2012 standard.

Pipe Materials

The pipes and pipe fittings according to the present invention are made from plastic. Usually, plastic pipes are made from thermoplastic materials. Suitable plastic materials include polyolefins, preferably polyethylene (PE) and/or polypropylene (PP). In a preferred embodiment of the invention, the pipe is made from polyethylene (PE) and/or polypropylene (PP).

Plastic pipes and pipe fittings of the present invention, preferably made from PE and/or PP, coated with a polyurea-based coating advantageously provide for longevity, light weight, chemical resistance, non-corrosive properties, and ease of making connections. In particular, pipes or pipe fittings of the invention have an improved mechanical strength and performance compared to a corresponding pipe or pipe fitting not comprising the polyurea-based coating, wherein the mechanical strength and performance relate to hydrostatic pressure resistance according to the Hydrostatic Pressure Test under ISO 1167 and/or resistance to failure according to the Notched Pipe Test under ISO 13479 and/or long-term hydrostatic strength according to ISO 9080:2012 standard. Therefore, plastic pipes and pipe fittings of the present invention may be used in a wide range of applications such as conveyance of drinking water, waste water, chemicals, heating fluid and cooling fluids, foodstuffs, ultra-pure liquids, slurries, gases, compressed air, irrigation, plastic pressure pipe systems, and vacuum system applications.

Pipes Standards

Pipes according to the present invention may be manufactured according to any applicable international or national standard industrial standard. Applicable standards may be selected from API 5L, ANSI/ASME B36.10M (Table 1), BS 1600, BS 1387, EN 10255 (formerly DIN 2448 and BS 1387), ISO 65:1981, JIS and/or ISO 9080:2012.

Pipes of the present invention may have any outside diameter (OD) or schedule (wall thickness). The OD may be designated as Nominal Pipe Size (NPS), Nominal Bore (NB), or Nominal Diameter (ND/DN). Designating the outside diameter allows pipes of the same size to be fit together regardless of the wall thickness. Pipe sizes are documented by a number of standards, including in the US, and in the United Kingdom

According to other preferred embodiments, a pipe of the present invention has an outer diameter (OD) of 10 mm to 1000 mm, preferably of 50 mm to 900 mm, more preferably of 100 mm to 750 mm, even more preferably of 400 mm to 600 mm, most preferably of 450 mm to 550 mm

The pipes of the present invention can be used for pressure piping and are characterized by a pressure rating. Generally, pipes used for pressure piping must carry pressures greater than 10 to 25 atmospheres. Commonly used pressure piping standards include, for example and not limited to ISO 3183, ISO L245, ASTM D2239 (PE pipe), or ISO 14692 (Petroleum and natural gas industries, glass-reinforced plastics (GRP) piping).

In preferred embodiments, the pipes of the present invention coated with a polyurea-based coating can be even used for high pressure and high temperature (HPTP) application in gas or oil drilling, wherein the HPTP application can involve a pressure of between 1 bar to 2500 bar, preferably of between 70 bar to 2000 bar, more preferably of between 300 to 1700 bar, even more preferably of between 500 bar to 1400 bar, most preferably of between 680 bar to 1100 bar.

In further preferred embodiments, the pipes or pipe fittings of the present invention coated with a polyurea-based coating provide for increased hydrostatic pressure resistance according to the Hydrostatic Pressure Test under ISO 1167 compared to corresponding pipes or pipe fittings not comprising the polyurea-based coating.

In other preferred embodiments, the pipes or pipe fittings of the present invention coated with a polyurea-based coating provide for an enhanced resistance to failure according to the Notched Pipe Test under ISO 13479 compared to corresponding pipes or pipe fittings not comprising the polyurea-based coating.

In other preferred embodiments, the pipes or pipe fittings of the present invention coated with a polyurea-based coating provide for a long-term hydrostatic strength according to ISO 9080:2012

Polyurea-Based Coatings

Polyurea

Polyurea is a polymeric material with alternating monomer units of isocyanates and amines that reacted with each other to form urea linkages. Polyurea may be described by the following chemical formula

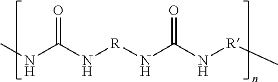

For example, polyurea is obtainable from the reaction of an isocyanate component and a synthetic resin blend component having amine functional groups. Typically, polyurea is obtainable via step-growth polymerization with high reaction rates. The quick cure time allows many coats to be built up quickly. This way, polyurea is suitable for coatings on large surface area projects, such as secondary containment, manhole and tunnel coatings, tank liners, or pipes. Some polyureas reach strengths of 6000 psi (40 MPa) tensile and over 500% elongation making it a tough coating.

Coating

The polyurea-based coating comprised by a pipe or pipe fitting according to the present invention is preferably applied at a controlled thickness. Preferably, the polyurea-based coating has a thickness of between 0.1 mm to 20 mm, preferably of between 0.5 mm to 15 mm, more preferably of between 1 mm to 10 mm, even more preferably of 2 mm to 6 mm, most preferably of between 2.5 mm to 3.5 mm.

The polyurea-based coating comprised by a pipe or pipe fitting of the present invention provides for enhanced mechanical strength and performance of the pipe or pipe fitting comprising the polyurea-based coating compared to a corresponding pipe or pipe fitting not comprising the polyurea-based coating. In this regard, mechanical strength and performance relate to hydrostatic pressure resistance according to the Hydrostatic Pressure Test under ISO 1167 and/or resistance to failure according to the Notched Pipe Test under ISO 13479 and/or long-term hydrostatic strength according to ISO 9080:2012 standard.

Specifically, the polyurea-based coating comprised by a pipe or pipe fitting of the present invention increases the resistance of a pipe or pipe fitting to harsh physical and chemical conditions, such as high pressures and/or high temperatures and/or corrosive substances when compared to a corresponding pipe or pipe fitting not comprising the polyurea-based coating by at least between 0.1 to 200%, preferably of between 1 to 100%, more preferably of at least between 10 to 90%, even more preferably of at least between 25 to 70%, most preferably of at least between 40 to 60%. For example, the polyurea-based coating provides for an increase in the long-term hydrostatic strength according to ISO 9080:2012 standard and/or pressure resistance of the pipe or pipe fitting and/or minimum critical pressure for rapid crack propagation (RCP) of the pipe or pipe fitting of at least between 0.1 to 200%, preferably of between 1 to 100%, more preferably of at least between 10 to 90%, even more preferably of at least between 25 to 70%, most preferably of at least between 40 to 60%, when compared to a corresponding pipe or pipe fitting not comprising the polyurea-based coating.

In another example, the polyurea-based coating provides for an increase in the test time until failure of at least between 0.1 to 1000%, preferably of at least between 1 to 700%, more preferably of at least between 10 to 500%, when measured according to the Hydrostatic Pressure Test under ISO 1167 and compared to a corresponding pipe or pipe fitting not comprising the polyurea-based coating. In a further example, the polyurea-based coating provides for an increase in the test time until failure of at least 1%, preferably of at least 10%, more preferably of at least 100%, even more preferably of at least 400%, most preferably of at least 600%, when measured according to the Hydrostatic Pressure Test under ISO 1167 and compared to a corresponding pipe or pipe fitting not comprising the polyurea-based coating.

In yet another example, the polyurea-based coating provides for an increase in the test time until failure of at least between 0.01 to 200%, preferably of at least between 0.1 to 150%, more preferably of at least between 1 to 120%, most preferably of at least between 1 to 100%, when measured according to the Notched Pipe Test under ISO 13479 and compared to a corresponding pipe or pipe fitting not comprising the polyurea-based coating. In a further example, the polyurea-based coating provides for an increase in the test time until failure of at least 1%, preferably of at least 5%, more preferably of at least 20%, even more preferably of at least 50%, most preferably of at least 100%, when measured according to the Notched Pipe Test under ISO 13479 and compared to a corresponding pipe or pipe fitting not comprising the polyurea-based coating.

This way, plastic pipes or pipe fittings equipped with a polyurea-based coating according to the present invention allow for an increased structural integrity, reliability and safety.

Process of Manufacturing PE and/or PP Pipes Equipped with a Polyurea-Based Coating

The polyurea-based coating can be applied to the pipe or pipe fitting by any coating methods known in the art, such as spraying, immersion in a bath or on-site application.

For pipes or pipe fittings according to the present invention any polyurea coating method known in the art may be used. For example, a two-component polyurea spray system may be used. A two-component polyurea spray system usually comprises an isocyanate component and a synthetic resin blend component having amine functional groups. Typically, polyurea is obtainable via step-growth polymerization with high reaction rates. The quick cure time allows many coats to be built up quickly. This way, polyurea is suitable for coatings on large surface area projects, such as secondary containment, manhole and tunnel coatings, tank liners, or pipes. Commercially available polyurea-based coatings which may be used in the present invention alone or in combination, are, for example, “Line-X XS-430” or “Line-X XS-350” from Line X LLC, Huntsville, Ala., USA.

Enhancement of Long-Term Hydrostatic Strength

A pipe or pipe fitting equipped with a polyurea-based coating of the present invention can be used under harsh physical and chemical conditions, for example, where harsh mechanical conditions and/or high pressures and/or high temperatures and/or corrosive substances are applied to the pipe or pipe fitting.

According to preferred embodiments of the present invention, plastic pipes equipped with a polyurea-based coating of the present invention provide for improved hydrostatic pressure resistance according to the Hydrostatic Pressure Test under ISO 1167 and/or resistance to failure according to the Notched Pipe Test under ISO 1347 and/or a long-term hydrostatic strength according to ISO 9080:2012 standard, when compared to uncoated plastic pipes.

In more preferred embodiments, the polyurea-based coating provides for an increase in the long-term hydrostatic strength according to ISO 9080:2012 standard and/or pressure resistance of the pipe or pipe fitting and/or minimum critical pressure for rapid crack propagation (RCP) of the plastic pipes or pipe fittings of at least between 0.1 to 200%, preferably of between 1 to 100%, more preferably of at least between 10 to 90%, even more preferably of at least between 25 to 70%, most preferably of at least between 40 to 60%, when compared to a corresponding pipe or pipe fitting not comprising the polyurea-based coating.

In another more preferred embodiment of the present invention, the polyurea-based coating provides for an increase in the test time until failure of at least between 0.1 to 1000%, preferably of at least between 1 to 700%, more preferably of at least between 10 to 500%, when measured according to the Hydrostatic Pressure Test under ISO 1167 and compared to a corresponding pipe or pipe fitting not comprising the polyurea-based coating. In a further more preferred embodiment, the polyurea-based coating provides for an increase in the test time until failure of at least 1%, preferably of at least 10%, more preferably of at least 100%, even more preferably of at least 400%, most preferably of at least 600%, when measured according to the Hydrostatic Pressure Test under ISO 1167 and compared to a corresponding pipe or pipe fitting not comprising the polyurea-based coating.

In yet another more preferred embodiment of the present invention, the polyurea-based coating provides for an increase in the test time until failure of at least between 0.01 to 200%, preferably of at least between 0.1 to 150%, more preferably of at least between 1 to 120%, most preferably of at least between 1 to 100%, when measured according to the Notched Pipe Test under ISO 13479 and compared to a corresponding pipe or pipe fitting not comprising the polyurea-based coating. In a further more preferred embodiment, the polyurea-based coating provides for an increase in the test time until failure of at least 1%, preferably of at least 5%, more preferably of at least 20%, even more preferably of at least 50%, most preferably of at least 100%, when measured according to the Notched Pipe Test under ISO 13479 and compared to a corresponding pipe or pipe fitting not comprising the polyurea-based coating.

Use of PE and/or PP Pipes Equipped with a Polyurea-Based Coating for High-Pressure Applications

According to preferred embodiments of the present invention, a pipe or pipe fitting according to the invention coated with a polyurea-based coating can be used for high-pressure applications. For example, PE and/or PP pipes equipped with a polyurea-based coating can be used for high pressure and high temperature (HPTP) applications in gas or oil drilling. In preferred embodiments, the HPTP applications can involve a pressure of between 1 bar to 2500 bar, preferably of between 70 bar to 2000 bar, more preferably of between 300 to 1700 bar, even more preferably of between 500 bar to 1400 bar, most preferably of between 680 bar to 1100 bar. This way, an alternative to pipes for HPTP applications made from carbon steel and/or other metals or alloys which are prone to corrosion and involve expensive maintenance is provided. Specifically, PE and/or PP pipes of the present invention equipped with a polyurea-based coating advantageously allow for improved mechanical strength and performance, wherein the mechanical strength and performance relate to hydrostatic pressure resistance according to the Hydrostatic Pressure Test under ISO 1167 and/or resistance to failure according to the Notched Pipe Test under ISO 13479 and/or long-term hydrostatic strength according to ISO 9080:2012 standard at low costs.

Use of PE and/or PP Pipes Equipped with a Polyurea-Based Coating for Conveying Materials

In another aspect, a pipe or pipe fitting of the present invention coated with a polyurea-based coating can be used for conveying fluids and/or bulk solids. For example, plastic pipes equipped with a polyurea-based coating can be used for conveying fluids selected from drinking water, waste water, chemicals, heating fluid and cooling fluids, foodstuffs, ultra-pure liquids, slurries, gases, and/or compressed air, natural gas, natural gas liquids, crude oil and/or refined petroleum. In preferred embodiments, PE and/or PP pipes or pipe fittings equipped with a polyurea-based coating can convey natural gas, natural gas liquids, crude oil and/or refined petroleum. PE and/or PP pipes or pipe fittings equipped with a polyurea-based coating are less prone to corrosion than commonly used carbon steel pipes. In other words, the present invention provides for reliable and cost-efficient alternatives for transporting fluids, preferably petroleum industry fluids.

A Multilayer Pipe or Pipe Fitting Comprising a Polyurea-Coated Pipe and/or Pipe Fitting

In a further aspect, the present invention relates to a multilayer pipe or pipe fitting comprising a pipe or pipe fitting according to the present invention. In preferred embodiments the multilayer pipe or pipe fitting is a reinforced thermoplastic pipe (RTP). This way, reinforcement layers of multilayer pipes or pipe fittings, which are usually made from expensive materials such as carbon steel, can be substituted for a pipe or pipe fitting according to the present invention. This allows for reducing the costs of multilayer pipes or pipe fittings without compromising requirements regarding the mechanical strength and performance of the multilayer pipe, in particular without compromising hydrostatic pressure resistance according to the Hydrostatic Pressure Test under ISO 1167 and/or resistance to failure according to the Notched Pipe Test under ISO 13479 and/or long-term hydrostatic strength according to ISO 9080:2012 standard.

A System Comprising a Polyurea-Coated Pipe and/or Pipe Fitting

In a further aspect, the present invention relates to a system comprising at least one pipe and/or at least one pipe fitting according to the present invention and/or at least one multilayer pipe or pipe fitting of the invention. Such a system can be, for example, a piping system, water drainage, sewage system, pipeline, gas pipeline and/or oil pipeline. A system of the present invention advantageously allows for use in applications requiring hydrostatic pressure resistance according to the Hydrostatic Pressure Test under ISO 1167 and/or resistance to failure according to the Notched Pipe Test under ISO 1347 and/or a long-term hydrostatic strength according to ISO 9080:2012 standard and/or in applications involving harsh physical and chemical conditions.

### Examples

1. Preparation of Polyurea-Coated Plastic Pipes.

In the present invention, polyurea-based coatings were made from the commercially available two-component polyurea systems “Line-X XS-430” or “Line-X XS-350” from Line X LLC, Huntsville, Ala., USA.

Pipes coated with the polyurea-based coatings were BorSafe HE3490LS HDPE pipes with an outer diameter (OD) of 32 mm and 110 mm, respectively.

The polyurea-based coatings were applied by standard spraying application. For example, in a typical procedure, the pipes to be equipped with a polyurea-based coating were subjected to a surface preparation step first. In the surface preparation step, the pipes were treated with a surface preparation chemical, either LX-1275 commercially available from Line X LLC, Huntsville, Ala., USA, or methyl ethyl ketone (MEK) and then given time to dry off as per manufacturer recommendation. In an alternative approach, in the surface preparation step, the surface of the pipe was etched using 40 grit sandpaper followed by flame treatment. In a second step, the polyurea-based coating was applied to the surface-treated pipes in a thickness of 3 mm.

TABLE 1
Preparation of polyurea-coated BorSafe HE3490LS
HDPE pipes. In all samples 1 to 8, the pipes
were equipped with a polyurea coating of 3 mm.

| Sample | OD (mm) | Surface preparation | Polyurea-coating |
|---|---|---|---|
| 1 | 32 | LX-1275 surface cleaner | Line-X XS-350 (black) |
| 2 | 32 | LX-1275 surface cleaner | Line-X XS-430 (grey) |
| 3 | 32 | Etching with 40 grit sand | Line-X XS-350 (black) |
| | | paper followed by flame | |
| | | treatment | |
| 4 | 32 | Wiping with MEK | Line-X XS-350 (black) |
| 5 | 110 | LX-1275 surface cleaner | Line-X XS-350 (black) |
| 6 | 110 | LX-1275 surface cleaner | Line-X XS-430 (black) |
| 7 | 110 | Etching with 40 grit sand | Line-X XS-350 (grey) |
| | | paper followed by flame | |
| | | treatment | |
| 8 | 110 | Wiping with MEK | Line-X XS-350 (black) |

2. Performance of Polyurea-Coated Plastic Pipes

The polyurea-coated pipes according to samples 1 to 8 were evaluated in a Hydrostatic Pressure Test (HPT) according to ISO 1167 (samples 1 to 4) and a Notched Pipe Test (NPT) according to ISO 13479 (samples 5 to 8).

2.1. Hydrostatic Pressure Test (HPT) According to ISO 1167

In a Hydrostatic Pressure Test (HPT) according to ISO 1167, the ability of a pipe to hold pressure without failure is tested.

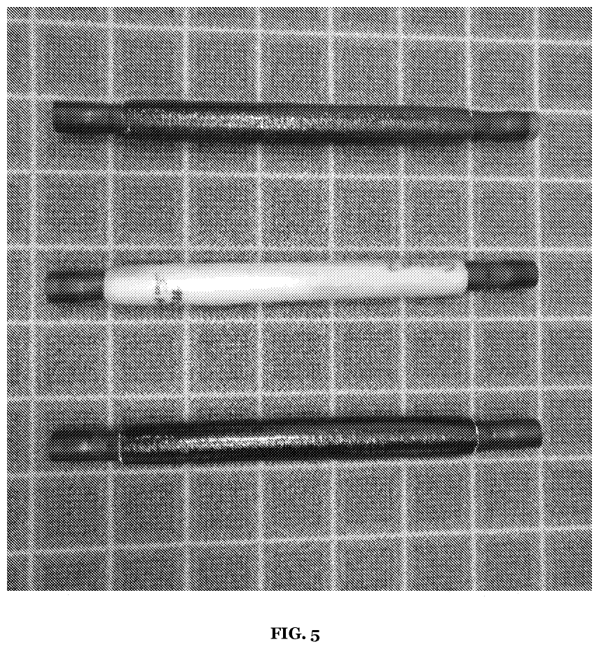

For the HPT according to ISO 1167, samples 1 to 4 made from BorSafe HE3490LS HDPE pipes with an outer diameter (OD) of 32 mm were tested against corresponding uncoated BorSafe HE3490LS HDPE pipes (references 1 to 3). Failed pipes are shown in FIG. 5. The results of the HPT are summarized in the following Table 2.

TABLE 2
Results of HPT according to ISO 1167
at 80° C. and a pressure of 12.2 bar.

| | Test time until | Increase test time until failure (%) | | |
|---|---|---|---|---|
| Sample | failure (h) | vs Ref. 1 | vs Ref. 2 | vs Ref. 3 |
| 1 | 2565 | 618 | 641 | 857 |
| 2 | 273 | −24 | −21 | 2 |
| 3 | — | | | |
| 4 | 2027 | 468 | 486 | 656 |
| Reference 1 | 357 | | | |
| Reference 2 | 346 | | | |
| Reference 3 | 268 | | | |

As can be derived from Table 2, samples 1 to 4 provided for a test time until failure of 2565 and 2027 hours, respectively. This corresponds to an increase in the test time until failure of up to 857% (sample 1 vs. reference 3). Thus, polyurea-coated pipes according to the present invention significantly outperform uncoated reference pipes.

2.2 Notched Pipe Test (NPT) According to ISO 13479

In a Notched Pipe Test (NPT) according to ISO 13479, the ability of a material to withstand slow crack growth (SCG) is tested. All tested pipes, i.e. polyurea-coated pipes according to the present invention and uncoated reference pipes were uniformly notched before beginning the test.

For the NPT according to ISO 13479, samples 5 to 8 made from BorSafe HE3490LS HDPE pipes with an outer diameter (OD) of 110 mm were tested against corresponding uncoated HE3490LS HDPE pipes (references 1 to 3). The results of the NPT are summarized in the following table 3.

TABLE 3
Results of NPT according to ISO 13479
at 80° C. and a pressure of 9.2 bar.

| | Test time until | Increase test time until failure (%) | | |
|---|---|---|---|---|
| Sample | failure (h) | vs Ref. 1 | vs Ref. 2 | vs Ref. 3 |
| 5 | 2095 | 8 | 27 | 31 |
| 6 | 3500 | 81 | 111 | 119 |
| 7 | 1778 | −8 | 7 | 11 |
| 8 | 1630 | −16 | −2 | 2 |
| Reference 1 | 1934 | | | |
| Reference 2 | 1655 | | | |
| Reference 3 | 1599 | | | |

As can be derived from Table 3, an improved performance, i.e. a greater ability of a material to withstand slow crack growth (SCG) under NPT according to ISO 13479 at 80° C. and a pressure of 9.2 bar, was observed for the pipes equipped with a polyurea-based coating according to samples 5, 6, and 7 (see Table 1 above) compared to the uncoated reference pipes.

### LIST OF EMBODIMENTS

A 1^{st} embodiment of the present invention relates to pipe or pipe fitting comprising a polyurea-based coating, wherein the pipe or pipe fitting is made from plastic, wherein the plastic is selected from polyolefins, preferably polyethylene (PE) and/or polypropylene (PP), and wherein the mechanical strength and performance of the pipe or pipe fitting comprising the polyurea-based coating is improved over a corresponding pipe or pipe fitting not comprising the polyurea-based coating, wherein the mechanical strength and performance relate to hydrostatic pressure resistance according to the Hydrostatic Pressure Test under ISO 1167 and/or resistance to failure according to the Notched Pipe Test under ISO 13479 and/or long-term hydrostatic strength according to ISO 9080:2012 standard.
According to a 2^{nd} embodiment of the present invention, in the pipe or pipe fitting of the preceding embodiment, the polyurea-based coating completely covers the pipe or pipe fitting, or the polyurea-based coating only covers parts of the pipe or pipe fitting.
According to a 3^{rd} embodiment of the present invention, in the pipe or pipe fitting of any one of the preceding embodiments, the polyurea-based coating covers an inside wall of the pipe or pipe fitting and/or an outside wall of the pipe or pipe fitting.
According to an 4^{th} embodiment of the present invention, in the pipe or pipe fitting of any one of the preceding embodiments, the polyurea-based coating has a thickness of between 0.1 mm to 20 mm, preferably of between 0.5 mm to 15 mm, more preferably of between 1 mm to 10 mm, even more preferably of 2 mm to 6 mm, most preferably of between 2.5 mm to 3.5 mm.
According to a 5^{th} embodiment of the present invention, in the pipe or pipe fitting of any one of the preceding embodiments, the pipe has an outer diameter (OD) of 10 mm to 1000 mm, preferably of 50 mm to 900 mm, more preferably of 100 mm to 750 mm, even more preferably of 400 mm to 600 mm, most preferably of 450 mm to 550 mm.
According to a 6^{th} embodiment of the present invention, in the pipe or pipe fitting of any one of the preceding embodiments, the polyurea-based coating provides for an increase in the long-term hydrostatic strength according to ISO 9080:2012 standard and/or pressure resistance of the pipe or pipe fitting and/or minimum critical pressure for rapid crack propagation (RCP) of the pipe or pipe fitting of at least between 0.1 to 200%, preferably of between 1 to 100%, more preferably of at least between 10 to 90%, even more preferably of at least between 25 to 70%, most preferably of at least between 40 to 60%, when compared to a corresponding pipe or pipe fitting not comprising the polyurea-based coating.
According to an 7^{th} embodiment of the present invention, in the pipe or pipe fitting of any one of the preceding embodiments, the polyurea-based coating provides for an increase in the test time until failure of at least between 0.1 to 1000%, preferably of at least between 1 to 700%, more preferably of at least between 10 to 500%, when measured according to the Hydrostatic Pressure Test under ISO 1167 and compared to a corresponding pipe or pipe fitting not comprising the polyurea-based coating.
According to a 8^{th} embodiment of the present invention, in the pipe or pipe fitting of any one of the preceding embodiments, the polyurea-based coating provides for an increase in the test time until failure of at least 1%, preferably of at least 10%, more preferably of at least 100%, even more preferably of at least 400%, most preferably of at least 600%, when measured according to the Hydrostatic Pressure Test under ISO 1167 and compared to a corresponding pipe or pipe fitting not comprising the polyurea-based coating.
According to a 9^{th} embodiment of the present invention, in the pipe or pipe fitting of any one of the preceding embodiments, the polyurea-based coating provides for an increase in the test time until failure of at least between 0.01 to 200%, preferably of at least between 0.1 to 150%, more preferably of at least between 1 to 120%, most preferably of at least between 1 to 100%, when measured according to the Notched Pipe Test under ISO 13479 and compared to a corresponding pipe or pipe fitting not comprising the polyurea-based coating.
According to a 10^{th} embodiment of the present invention, in the pipe or pipe fitting of any one of the preceding embodiments, the polyurea-based coating provides for an increase in the test time until failure of at least 1%, preferably of at least 5%, more preferably of at least 20%, even more preferably of at least 50%, most preferably of at least 100%, when measured according to the Notched Pipe Test under ISO 13479 and compared to a corresponding pipe or pipe fitting not comprising the polyurea-based coating.
A 11^{th} embodiment of the present invention relates to the use of a pipe or pipe fitting coated with a polyurea-based coating according to any one of the 1^{st} to the 10^{th} embodiments for applications requiring enhanced hydrostatic pressure resistance according to the Hydrostatic Pressure Test under ISO 1167 and/or increased resistance to failure according to the Notched Pipe Test under ISO 13479 and/or long-term hydrostatic strength according to ISO 9080:2012 standard.
A 12^{th} embodiment of the present invention relates to the use of a pipe or pipe fitting coated with a polyurea-based coating according to any one of the 1^{st} to the 10^{th} embodiments for a high pressure and high temperature (HPTP) application in gas or oil drilling, wherein the pipe or pipe fitting is a PE and/or PP pipe, and wherein the high pressure application involves a pressure of between 1 bar to 2500 bar, preferably of between 70 bar to 2000 bar, more preferably of between 300 to 1700 bar, even more preferably of between 500 bar to 1400 bar, most preferably of between 680 bar to 1100 bar.
A 13^{th} embodiment of the present invention relates to the use of a pipe or pipe fitting coated with a polyurea-based coating according to any one of the 1^{st} to the 10^{th} embodiments for conveying fluids and/or bulk solids, preferably wherein the fluid is selected from drinking water, waste water, chemicals, heating fluid and cooling fluids foodstuffs, ultra-pure liquids, slurries, gases, and/or compressed air, natural gas, natural gas liquids, crude oil and/or refined petroleum, preferably the fluid is natural gas, natural gas liquids, crude oil and/or refined petroleum.
A 14^{th} embodiment of the present invention relates to a multilayer pipe or pipe fitting, preferably a reinforced thermoplastic pipe (RTP), comprising a pipe or pipe fitting according to any one of the 1^{st} to the 10^{th} embodiments.
A 15^{th} embodiment of the present invention relates to a system comprising at least one pipe and/or at least one pipe fitting according to any one of the 1^{st} to the 10^{th} embodiments and/or at least one multilayer pipe or pipe fitting according to the 14^{th} embodiment, preferably, wherein the system is a piping system, water drainage system, sewage system, pipeline, gas pipeline and/or oil pipeline.

1. Pipe or pipe fitting comprising a polyurea-based coating, wherein the pipe or pipe fitting is made from plastic, wherein the plastic is selected from polyolefins, preferably polyethylene (PE) and/or polypropylene (PP), and wherein the mechanical strength and performance of the pipe or pipe fitting comprising the polyurea-based coating is improved over a corresponding pipe or pipe fitting not comprising the polyurea-based coating, wherein the mechanical strength and performance relate to hydrostatic pressure resistance according to the Hydrostatic Pressure Test under ISO 1167 and/or resistance to failure according to the Notched Pipe Test under ISO 13479 and/or long-term hydrostatic strength according to ISO 9080:2012 standard.

2. The pipe or pipe fitting of claim 1, wherein the polyurea-based coating completely covers the pipe or pipe fitting, or wherein the polyurea-based coating only covers parts of the pipe or pipe fitting.

3. The pipe or pipe fitting of claim 1, wherein the polyurea-based coating covers an inside wall of the pipe or pipe fitting and/or an outside wall of the pipe or pipe fitting.

4. The pipe or pipe fitting of claim 1, wherein the polyurea-based coating has a thickness of between 0.1 mm to 20 mm, preferably of between 0.5 mm to 15 mm, more preferably of between 1 mm to 10 mm, even more preferably of 2 mm to 6 mm, most preferably of between 2.5 mm to 3.5 mm.

5. The pipe or pipe fitting of claim 1, wherein the pipe or pipe fitting has an outer diameter (OD) of 10 mm to 1000 mm, preferably of 50 mm to 900 mm, more preferably of 100 mm to 750 mm, even more preferably of 400 mm to 600 mm, most preferably of 450 mm to 550 mm.

6. The pipe or pipe fitting of claim 1, wherein the polyurea-based coating provides for an increase in the long-term hydrostatic strength according to ISO 9080:2012 standard and/or pressure resistance of the pipe or pipe fitting and/or minimum critical pressure for rapid crack propagation (RCP) of the pipe or pipe fitting of at least between 0.1 to 200%, preferably of between 1 to 100%, more preferably of at least between 10 to 90%, even more preferably of at least between 25 to 70%, most preferably of at least between 40 to 60%, when compared to a corresponding pipe or pipe fitting not comprising the polyurea-based coating.

7. The pipe or pipe fitting of claim 1, wherein the polyurea-based coating provides for an increase in the test time until failure of at least between 0.1 to 1000%, preferably of at least between 1 to 700%, more preferably of at least between 10 to 500%, when measured according to the Hydrostatic Pressure Test under ISO 1167 and compared to a corresponding pipe or pipe fitting not comprising the polyurea-based coating.

8. The pipe or pipe fitting of claim 1, wherein the polyurea-based coating provides for an increase in the test time until failure of at least 1%, preferably of at least 10%, more preferably of at least 100%, even more preferably of at least 400%, most preferably of at least 600%, when measured according to the Hydrostatic Pressure Test under ISO 1167 and compared to corresponding a pipe or pipe fitting not comprising the polyurea-based coating.

9. The pipe or pipe fitting of claim 1, wherein the polyurea-based coating provides for an increase in the test time until failure of at least between 0.01 to 200%, preferably of at least between 0.1 to 150%, more preferably of at least between 1 to 120%, most preferably of at least between 1 to 100%, when measured according to the Notched Pipe Test under ISO 13479 and compared to a corresponding pipe or pipe fitting not comprising the polyurea-based coating.

10. The pipe or pipe fitting of claim 1, wherein the polyurea-based coating provides for an increase in the test time until failure of at least 1%, preferably of at least 5%, more preferably of at least 20%, even more preferably of at least 50%, most preferably of at least 100%, when measured according to the Notched Pipe Test under ISO 13479 and compared to a corresponding pipe or pipe fitting not comprising the polyurea-based coating.

11. The use of a pipe or pipe fitting coated with a polyurea-based coating according to claim 1 for applications requiring enhanced hydrostatic pressure resistance according to the Hydrostatic Pressure Test under ISO 1167 and/or increased resistance to failure according to the Notched Pipe Test under ISO 13479 and/or long-term hydrostatic strength according to ISO 9080:2012 standard.

12. The use of a pipe or pipe fitting coated with a polyurea-based coating according to claim 1 for a high pressure and high temperature (HPTP) application in gas or oil drilling, wherein the pipe or pipe fitting is a PE and/or PP pipe, and wherein the HPTP application involves a pressure of between 1 bar to 2500 bar, preferably of between 70 bar to 2000 bar, more preferably of between 300 to 1700 bar, even more preferably of between 500 bar to 1400 bar, most preferably of between 680 bar to 1100 bar.

13. The use of a pipe or pipe fitting coated with a polyurea-based coating according to claim 1 for conveying fluids and/or bulk solids, preferably wherein the fluid is selected from drinking water, waste water, chemicals, heating fluid and cooling fluids foodstuffs, ultra-pure liquids, slurries, gases, and/or compressed air, natural gas, natural gas liquids, crude oil and/or refined petroleum, preferably the fluid is natural gas, natural gas liquids, crude oil and/or refined petroleum.

14. A multilayer pipe or pipe fitting, preferably a reinforced thermoplastic pipe (RTP), comprising a pipe or pipe fitting according to claim 1.

15. A system comprising at least one pipe and/or at least one pipe fitting according to claim 1 and/or at least one multilayer pipe or pipe fitting according to claim 14, preferably, wherein the system is a piping system, water drainage system, sewage system, pipeline, gas pipeline and/or oil pipeline.
